(19) United States
(12) Patent Application Publication
(10) Pub. No.: US 2012/0127227 A1
(43) Pub. Date: May 24, 2012

(54) IMAGE RECORDING APPARATUS AND METHOD OF CONTROLLING IMAGE RECORDING APPARATUS

(75) Inventor: Tomoko GOCHO, Tokyo (JP)

(73) Assignee: OLYMPUS CORPORATION, Tokyo (JP)

(21) Appl. No.: 12/949,855

(22) Filed: Nov. 19, 2010

(30) Foreign Application Priority Data
Nov. 26, 2009 (JP) 2009-269177

(51) Int. Cl. B41J 29/38

(52) U.S. Cl. 347/16

(57) ABSTRACT

An image recording apparatus records an image on a record medium according to job information from an upper device, calculates an amount of movement in a direction substantially orthogonal to a conveyance direction of the record medium based on a reference position, issues an instruction to perform perforation processing based on the amount of movement, and provides perforation on the record medium based on the instruction.

### CROSS-REFERENCE TO RELATED APPLICATION

This application is based upon and claims the benefit of priority of the prior Japanese Patent Application No. 2009-269177, filed on Nov. 26, 2009, the entire contents of which are incorporated herein by reference.

### BACKGROUND OF THE INVENTION

Some embodiments according to the present invention relate to an image recording apparatus which records images by fixing ink, toner, etc. to a record medium such as paper, film, etc., and more specifically to an image recording apparatus capable of performing perforation processing.

### DESCRIPTION OF THE RELATED ART

Some of the latest image recording apparatuses such as printers, FAX, etc. have the function of providing perforation at a desired position on the record medium for recording an image as a post-processing mechanism.

For example, Japanese Laid-open Patent Publication No. 2000-61889 (hereinafter referred to as patent document 1 which is incorporated herein by reference) proposes a random perforation processing device capable of providing vertical perforation which can perform perforation processing without stopping of conveying of a record medium.

The device according to the patent document 1 reads the mark recorded on the record medium, controls the driving timing of a perforation edge based on the read mark, and performs perforation processing at a desired position of the record medium.

### SUMMARY OF THE INVENTION

The image recording apparatus according to an embodiment of the present invention which records an image on a record medium according to job information from an upper device, includes: a perforation control unit calculating an amount of movement in a direction substantially orthogonal to a conveyance direction of the record medium based on a reference position, and issuing an instruction to perform perforation processing based on the amount of movement; and a perforation edge horizontal movement unit moving based on the instruction and providing perforation on the record medium.

The method of controlling the image recording apparatus according to an embodiment of the present invention which records an image on a record medium according to job information from an upper device, includes: calculating an amount of movement in a direction substantially orthogonal to a conveyance direction of the record medium based on a reference position, and issuing an instruction to perform perforation processing based on the amount of movement; and moving based on the instruction and issuing a instruction to provide perforation on the record medium.

### BRIEF DESCRIPTION OF THE DRAWINGS

The present invention will be more apparent from the following detailed description when the accompanying drawings are referenced.

FIG. 1 illustrates the entire configuration of the image recording apparatus according to an embodiment of the present invention;

FIG. 2 is a schematic diagram as a sectional view of the image recording apparatus according to an embodiment of the present invention;

FIG. 3 is an example of a configuration of the perforation processing unit provided for an image recording apparatus 1 according to an embodiment of the present invention;

FIG. 4 is an explanatory view of the relationship between a medium end portion detection unit and a perforation edge horizontal movement unit;

FIG. 5A illustrates a method of providing perforation in a medium end portion following mode;

FIG. 5B illustrates a method of providing perforation in an image reference following mode;

FIG. 6 is an explanatory view of a controlling method in the medium end portion following mode;

FIG. 7 is an explanatory view of a controlling method in the image reference following mode;

FIG. 8 is an example of a configuration of an image information table;

FIG. 9 is an explanatory view of a controlling method using the center of an image in the image reference following mode; and

FIG. 10 is a flowchart of the operation in the perforation processing performed by the image recording apparatus according to an embodiment of the present invention.

### DESCRIPTION OF THE PREFERRED EMBODIMENTS

The embodiment of the present invention is described below in detail with reference to the attached drawings. In the description below, an example of a full line printer device in the ink jet system is described as the image recording apparatus according to the present embodiment.

An ink jet printer jets ink drops from a plurality of nozzles of a recording head onto the record medium held and conveyed by a conveying system, and records a high quality image at a high speed. The ink jet printer is widely used in offices where images are recorded on record media (paper), for example, in cut sheet form. Recently, the throughput can be improved by configuring a line head by a large number of recording heads arranged in the direction orthogonal to the conveyance direction of record media, thereby utilizing the printer for industrial use in which images are recorded on the record media such as a roll of paper (continuous paper), etc.

The image recording apparatus according to the present embodiment can be a device other than a printer, and can be an image recording apparatus not in the ink jet system but in an electrostatic recording system as an image recording system.

In the following example, the record medium on which images are recorded by the image recording apparatus is a roll of paper, but can also be paper in cut sheet form, and the material other than paper can be used. For example, film etc. can be used.

In the following descriptions, a sheet refers to one cut from a roll of paper into a predetermined size, and a page refers to the front surface and the back surface of each sheet.

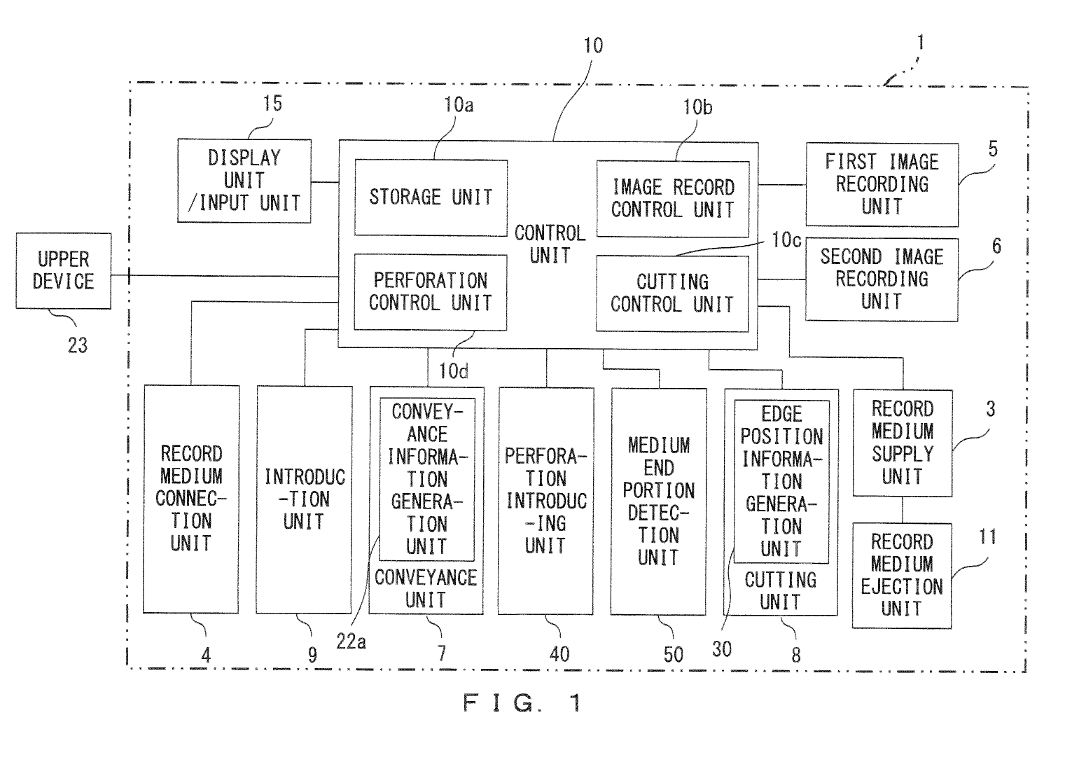

FIG. 1 illustrates the entire configuration of the image recording apparatus according to the present embodiment.

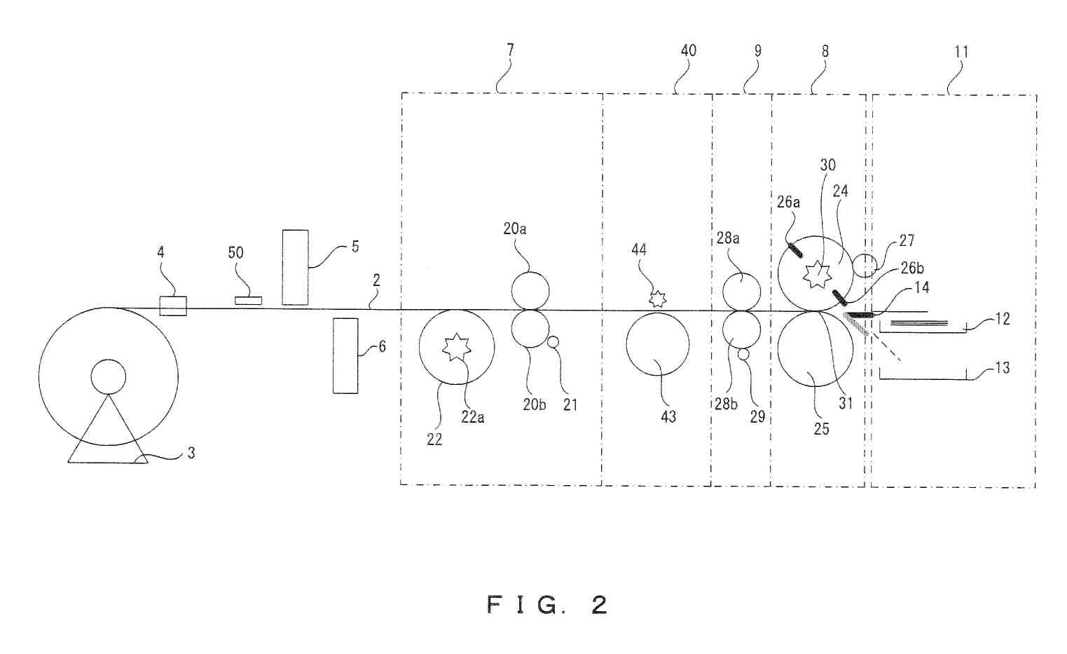

FIG. 2 is a schematic diagram as a sectional view of the image recording apparatus according to the present embodiment.

In FIGS. 1 and 2, the image recording apparatus 1 is configured by a record medium supply unit 3, a record medium connection unit 4, a first image recording unit 5, a second image recording unit 6, a conveyance unit 7, a cutting unit 8, an introduction unit 9, a control unit 10, and a display unit/input unit 15.

The record medium supply unit 3 winds a continuous record medium 2 in roll, form (hereinafter referred to simply as a record medium) around itself. The record medium connection unit 4 connects the record medium 2 conveyed from the record medium supply unit 3 to the conveyance path. The first image recording unit 5 records an image on the front surface of the record medium 2 conveyed at an instruction of the control unit 10. The second image recording unit 6 records an image on the back surface of the record medium 2. The conveyance unit 7 conveys the record medium 2 on which an image is recorded by the first image recording unit 5 and the second image recording unit 6 with the predetermined tension and speed. A perforation introducing unit 40 provides the perforation parallel to the conveyance direction of the record medium 2 (hereinafter referred to as vertical perforation) according to an instruction from the control unit 10. The cutting unit 8 cuts the record medium 2 into a predetermined length. The introduction unit 9 is arranged between the conveyance unit and the cutting unit 8 to introduce the record medium 2 to the cutting unit 8. The control unit 10 controls the entire image recording apparatus 1. The display unit/input unit 15 is used by a user to input various types of set information.

A record medium ejection unit 11 is provided behind the cutting unit 8 to store the record medium 2 cut by the cutting unit 8. The record medium ejection unit 11 is provided with a record medium stacker 12 for storing the record medium 2 on which images are recorded and a discarded medium stacker 13 for discarding unnecessary record medium 2. A switching plate 14 switches the ejecting destination of the record medium 2 between the stackers 12 and 13.

On the other hand, the conveyance unit 7 includes a nip roller pair 20 (20a and 20b) for nipping the record medium 2 and conveying it downstream. The nip roller pair 20 is driven by a nip roller drive motor 21. The conveyance unit 7 has a roller 22 rotated by the conveyance of the record medium 2, and the roller 22 has a conveyance information generation unit 22a for detecting the amount of conveyance of the record medium 2. The conveyance information generation unit 22a is configured by, for example, an encoder. The control unit 10 constantly monitors the encoder value output from the conveyance information generation unit 22a, and manages the current position of each sheet of the record medium 2 on the conveyance unit 7.

Furthermore, a medium end portion detection unit 50 is provided upstream of the first image recording unit 5. The medium end portion detection unit 50 detects the positions of the both ends of the record medium 2.

The record medium 2 is continuous paper, and the position of the record medium can change by some millimeters in the direction orthogonal to the conveyance direction of the record medium depending on the processing quality of the continuous paper. The control unit 10 acquires the both side end portion position information from the medium end portion detection unit 50, and thereby image recording apparatus 1 according to the present embodiment corrects the image recording position and the perforation processing position for the record medium 2. The medium end portion detection unit 50 is configured by, for example, a contact image sensor (CIS).

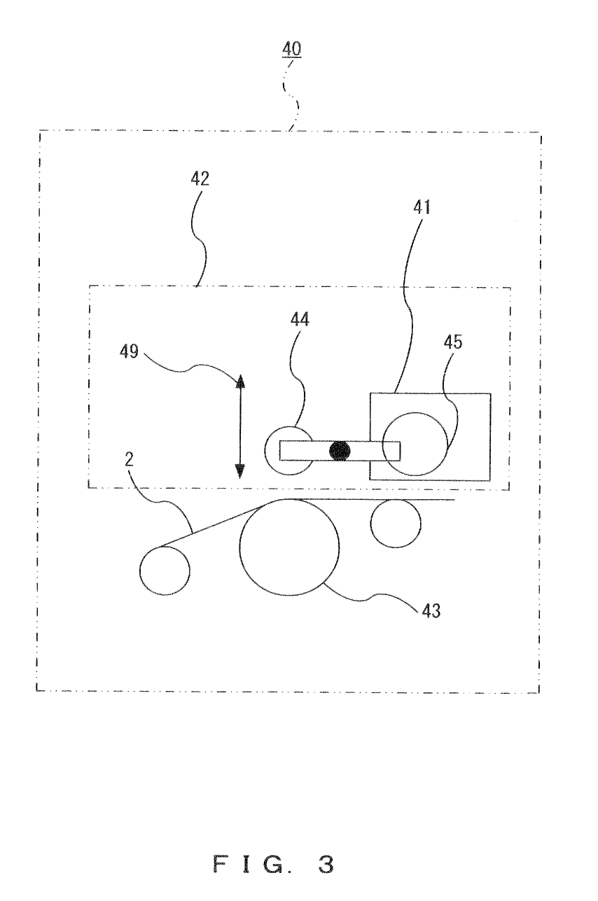

FIG. 3 is an example of a configuration of the perforation introducing unit 40 provided for the image recording apparatus 1 according to the present embodiment.

As illustrated in FIG. 3, the perforation introducing unit 40 has a perforation edge horizontal movement unit 41, a perforation processing unit 42, and an anvil roller 43.

The perforation edge horizontal movement unit 41 has a driving source not illustrated in the attached drawings, and moves in the direction orthogonal to the conveyance direction of the record medium 2. Thus, the position of a perforating edge 44 can be moved in the direction orthogonal to the conveyance direction on the record medium. The perforation processing unit 42 has a cam motor 45 provided with an eccentric cam and the perforating edge 44. In the perforation processing unit 42, the perforating edge 44 connected to the cam motor 45 moves in the direction of an arrow 49 by driving the cam motor 45, and the perforating edge 44 contacts or become detached from the record medium 2. By the perforating edge 44 contacting the record medium 2, perforation 47 is provided on the record medium 2. The anvil roller 43 has the function of supplying the record medium 2 downstream as well as the function as a backup roller when the perforating edge 44 contacts the record medium 2.

The perforation introducing unit 40 of the image recording apparatus 1 according to the present embodiment can be provided with a plurality of perforation processing units 42 to provide plural sequences of vertical perforation. In the following description, the perforation introducing unit 40 is provided with two perforation processing units 42.

The cutting unit 8 has a cutting roller 24 as a cutting side rotator which rotates at a predetermined number of rotations and an anvil roller 25 as a receiving side rotator which are located opposite each other so that the record medium 2 can be cut. A cutter edge 26 is provided on the periphery of the cutting roller 24, and cuts the record medium 2.

The cutting roller 24 is driven by a cutting roller drive motor 27 as a driving source. The cutting roller drive motor 27 uses the conveyance information generated by the conveyance information generation unit 22a as a control pulse, and establishes the synchronization between the conveying speed of the record medium 2 and the peripheral speed of the cutter edge 26.

An encoder can be attached to the cutting roller drive motor 27 so as to establish the synchronization between the conveying speed of the record medium 2 and the peripheral speed of the cutter edge 26 according to an encoder signal.

The introduction unit 9 is provided between the conveyance unit 7 and the cutting unit 8. The medium conveyance tension of the introduction unit 9 nips the record medium 2.

The introduction unit 9 includes a cutter supply roller pair 28 (28a and 28b) as a pair of introducing rotators introduces the record medium 2 to cutting unit 8 with the tension lower than the tension of the conveyance unit 7. The cutter supply roller pair 28 is driven by a cutter supply roller drive motor 29.

Described next is the control unit 10.

As illustrated in FIG. 1, the control unit 10 is provided with a storage unit 10a, an image record control unit 10b, a cutting control unit 10c, and a perforation control unit 10d. They are interconnected by a bus not illustrated in the attached drawings, and are also connected to an upper device 23.

The storage unit 10a stores an operation program of the image recording apparatus according to the present invention, and temporarily stores recorded data from the upper device 23, perforation processing information, etc. In addition, the storage unit 10a also stores various adjusting parameters etc. used in the image recording apparatus 1. The image record control unit 10b averages the conveyance information from the conveyance information generation unit 22a, and outputs the conveyance information about the record medium 2 to the first image recording unit 5, the second image recording unit 6, and the cutting control unit 10c.

The cutting control unit 10c issues a drive instruction to the cutting unit 8, acquires the cutting position information from an edge position information generation unit 30, and outputs a drive instruction according to the cutting position information to the perforation introducing unit 40.

The perforation control unit 10d has a perforation edge horizontal position calculation unit and a timing generation unit not illustrated in the attached drawings. The perforation edge horizontal position calculation unit calculates the horizontal position of the perforation according to the perforation edge processing information notified by the upper device 23 and the medium end portion position information from the medium end portion detection unit 50. The perforation edge horizontal position calculation unit issues a drive instruction to the perforation edge horizontal movement unit 41 based on the calculation result. The timing generation unit issues a drive instruction for the sheet to be perforated to the perforation processing unit 42 on the basis of the perforation edge processing information notified by the upper device 23.

Described next is the processing operation of the image recording apparatus 1 according to the present embodiment. The control unit 10 receives an image record command from the upper device 23 such as a personal computer (PC) etc., and performs an image recording process corresponding to the image record command. To perform these processes, the control unit 10 controls the drive of the first image recording unit 5, the second image recording unit 6, the conveyance unit 7, the cutting unit 8, the perforation introducing unit 40, and the introduction unit 9.

In the pre-processing stage before the image recording process, the record medium 2 is wound around and attached to the record medium supply unit 3 in the roll shape as described above. A back tension is supplied to the roll of the record medium 2 by the braking mechanism not illustrated in the attached drawings.

When the image recording process is started, the nip roller pair 20 of the image recording apparatus 1 conveys the record medium 2 to the first image recording unit 5 while maintaining a predetermined conveying speed of the record medium 2. When the record medium 2 is conveyed to a predetermined position, the first image recording unit 5 records an image on the surface of the record medium 2. When the record medium 2 is further conveyed, the second image recording unit 6 records the image on the back surface of the record medium 2.

In the image recording apparatus 1 according to the present embodiment, the above-mentioned rotary cutting unit 3 is used as a method of cutting the record medium 2 in a predetermined image recording unit. The peripheral speed of the cutter edge 26 of the cutting unit 8 is attained as a constant speed synchronous with the conveying speed of the record medium 2, thereby pressing the cutter edge 26 against the anvil roller 25 and cutting the record medium 2 in a predetermined size.

The edge position information generation unit 30 for detecting the position of the cutter edge 26 is provided on the drive axis of the cutting roller 24. The edge position information generation unit 30 is configured by, for example, an absolute encoder. When the attachment position of the cutter edge 26 is the origin position of the absolute encoder, the length of the periphery from the current position of the cutter edge 26 to the next cutting position can be obtained from the total length of the periphery of the cutting roller 24 and the resolution of the absolute encoder.

The cutting roller 24 and the anvil roller 25 have the inertial force higher than that of the nip roller pair 20, and rotate to keep the synchronization between the peripheral speed of the cutter edge and the conveying speed of the record medium. Then, the record medium 2 can be cut by being interposed between the cutting roller 24 and the anvil roller 25.

Described next in detail is the perforation processing as the characteristic of the image recording apparatus 1 according to the present embodiment.

The perforation processing position information is transmitted from the upper device 23 in each record sheet as job information together with the data (image data) specifying the image to be recorded. The perforation processing information includes the information about the presence/absence of the perforation processing, the perforation processing position, the length of the perforation processing etc. The information about the presence/absence of the perforation processing indicates whether or not the perforation processing is to be performed. The perforation processing position information indicates, for example, how many millimeters are reserved from the end portion of the image to be recorded to the position at which perforation is performed. The length information about the perforation processing indicates where the vertical perforation is to be provided in the conveyance direction in the position specified by the perforation processing position information.

The control unit 10 determines from the perforation processing presence/absence information the presence/absence of the perforation processing on the sheet received by the perforation introducing unit 40. If it is determined that the perforation processing on the sheet is present, the control unit 10 issues a calculate command to the perforation edge horizontal position calculation unit. The perforation edge horizontal position calculation unit calculates the horizontal movement position of the perforating edge 44 according to the perforation processing position information and the end portion position information about the medium end portion detection unit 50, and issues a drive command to the perforation edge horizontal movement unit 41.

The image recording apparatus 1 according to the present embodiment may have two modes, that is, a record medium end portion following mode and an image reference following mode, as the methods of calculating the horizontal movement position performed by the perforation edge horizontal position calculation unit. Described below are the methods of controlling the horizontal movement position for following the perforation in the record medium end portion following mode and the image reference following mode.

In the image recording apparatus 1 according to the present embodiment, before calculating the horizontal movement position in the above-mentioned record medium end portion following mode or the image reference following mode, it is necessary to first set an origin as the initial process. To calculate the horizontal movement position, it is necessary for the control unit 10 to hold the information indicating which position on the medium end portion detection unit 50 the position (origin sensor position) of a reference position detection unit 46 as an origin in the control coordinates system of the perforation edge horizontal movement unit 41 corresponds to. The origin is set in a factory etc. before the image recording apparatus 1 is shipped.

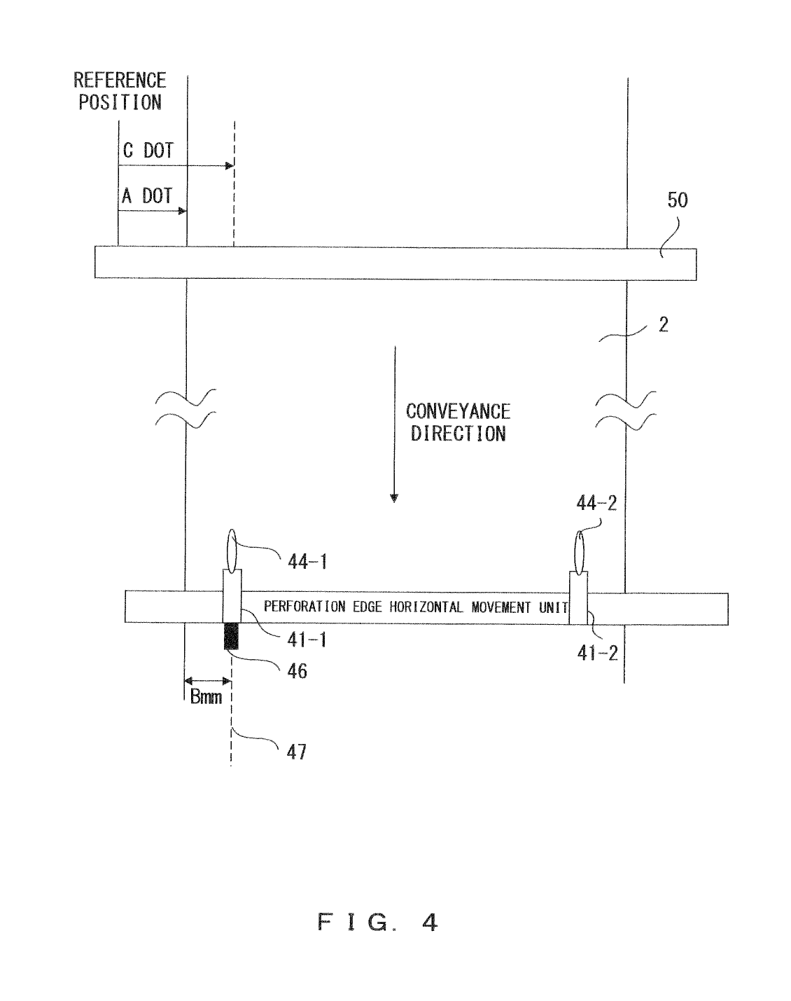

FIG. 4 is an explanatory view of the relationship between the medium end portion detection unit 50 and the perforation edge horizontal movement unit 41. In the image recording apparatus 1 according to the present embodiment, the perforation introducing unit 40 is provided with two perforation edge horizontal movement units 41-1 and 41-2 respectively having perforating edges 44-1 and 44-2. In the following description, only the perforation edge horizontal movement unit 41-1 is described as to the method of setting the origin of the perforation edge horizontal movement unit 41, but the origin setting method is similar for the perforation edge horizontal movement unit 41-2.

With reference to FIG. 4, the origin setting method is described by referring to the case in which the medium end portion detection unit 50 is a CIS type and has a resolution of 300 dpi (dot per inch).

In setting the origin, the perforation edge horizontal movement unit 41-1 is first moved to the position of the reference position detection unit 46 as a positioning point, then the record medium 2 is conveyed, and the perforation 47 is provided on the record medium 2 using the perforation edge 44-1. During the perforation processing, the medium end portion detection unit 50 detects the side end portion of the record medium 2, and notifies the control unit 10 of the ordinal number (dot number) of the position of the side end portion as the element configuring the medium end portion detection unit 50. The control unit 10 stores the ordinal number in the storage unit 10a. In the present embodiment, the value of the number is defined as A (dot). The A (dot) indicates that an element is the A-th dot from the leftmost element (reference position) in the elements configuring the medium end portion detection unit 50.

Next, the conveyance of the record medium 2 is stopped, and the position of the perforation processed on the record medium 2 from the end portion of the record medium 2 is measured. The measured value is defined as B mm.

The measured value B (mm) is input from the display unit/input unit 15 of the touch panel etc. provided for the image recording apparatus 1, or the upper device 23. From the input measured value B (mm), the control unit 10 obtains by the following equation the position C (dot) of an origin sensor 46 of the perforation edge horizontal movement unit in the control coordinates system on the dot elements of the medium end portion detection unit 50. In the equation, 1 inch≈25.4 (mm).

C=A+(B×300)/25.4

Then, the control unit 10 stores in a non-volatile storage area in the storage unit 10a the value of C obtained by the equation as an adjusted value indicating the origin of the perforation edge horizontal movement unit 41-1.

In this example, the position of the processed perforation from the medium end portion is measured, and the measured value B is input to the image recording apparatus. However, A CIS can be further provided downstream from the perforation introducing unit 40 so that the control unit 10 can read the position of the processed perforation according to the read information by the CIS.

Described below is the operating process performed during the image recording process in each mode in the image recording apparatus 1 according to the present embodiment in which the above-mentioned origin adjustment is made.

Described first is to perform the perforation processing in the medium end portion following mode.

In the medium end portion following mode, the perforation is provided with reference to the side end portion of the record medium 2.

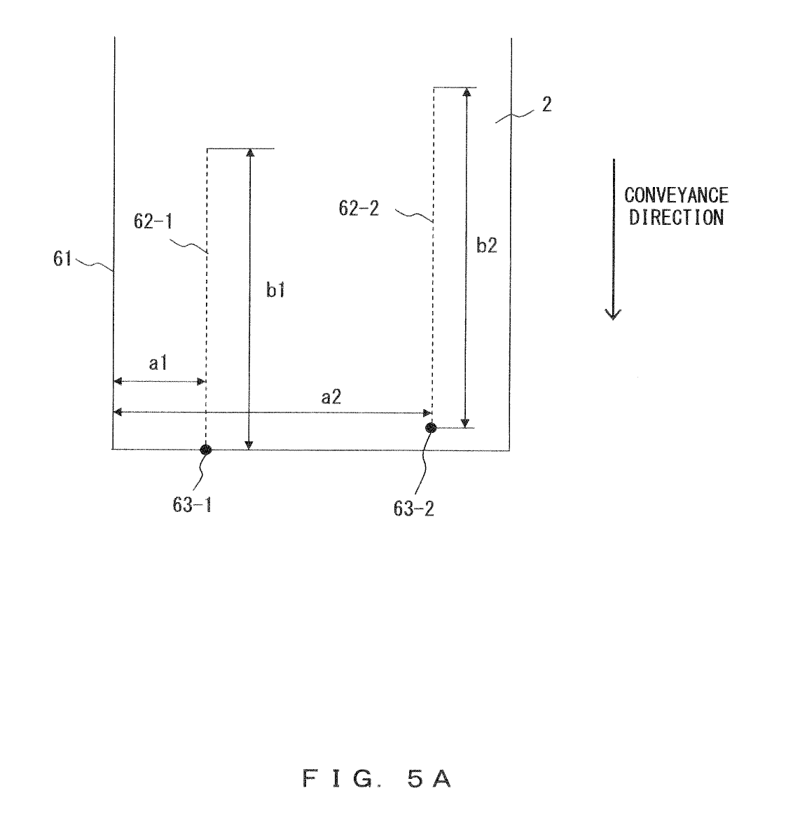

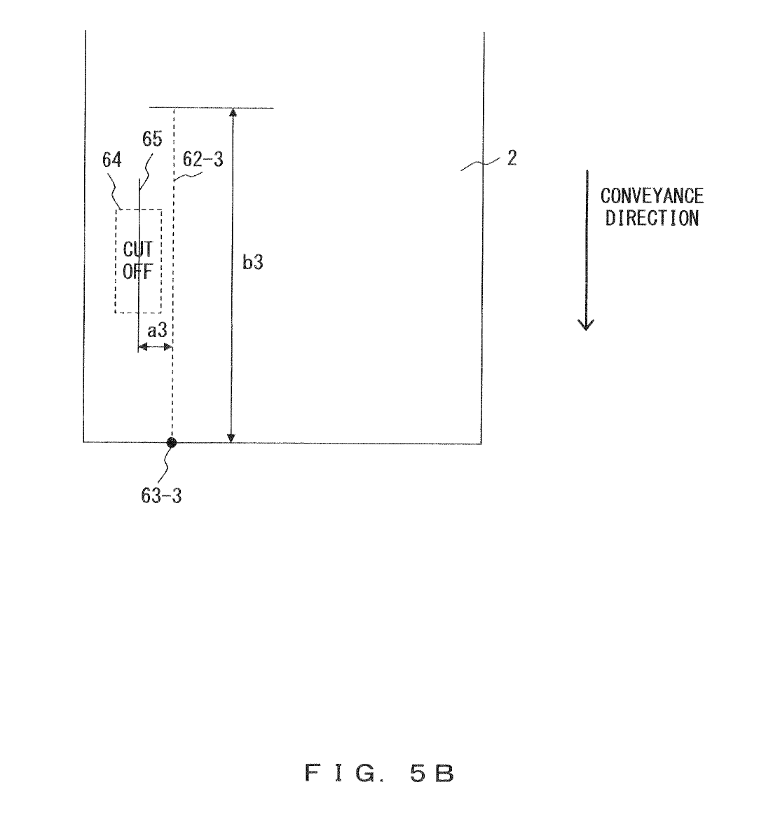

FIG. 5A illustrates a method of providing perforation in the medium end portion following mode.

As illustrated in FIG. 5A, perforation 62 is provided with reference to a side end portion 61 of the record medium 2 in the medium end portion following mode. In FIG. 5A, two streaks of perforation 62-1 and 62-2 are provided in the record medium 2.

The information about the perforation is included in the job information notified by the upper device 23 when an image is recorded in the medium end portion following mode. In FIG. 5A, the distance (a1 and a2 in FIG. 5A) from the side end portion 61 of the record medium 2, the length of the perforation (b1 and b2 in FIG. 5A), and the starting position (63-1 and 63-2 in FIG. 5A) of the perforation are stored in the job information as the information about the perforation in the medium end portion following mode. The perforation control unit 10d of the control unit 10 provides the perforation 62-1 and 62-2 with reference to the side end portion 61 of the record medium 2 according to the information about the perforation.

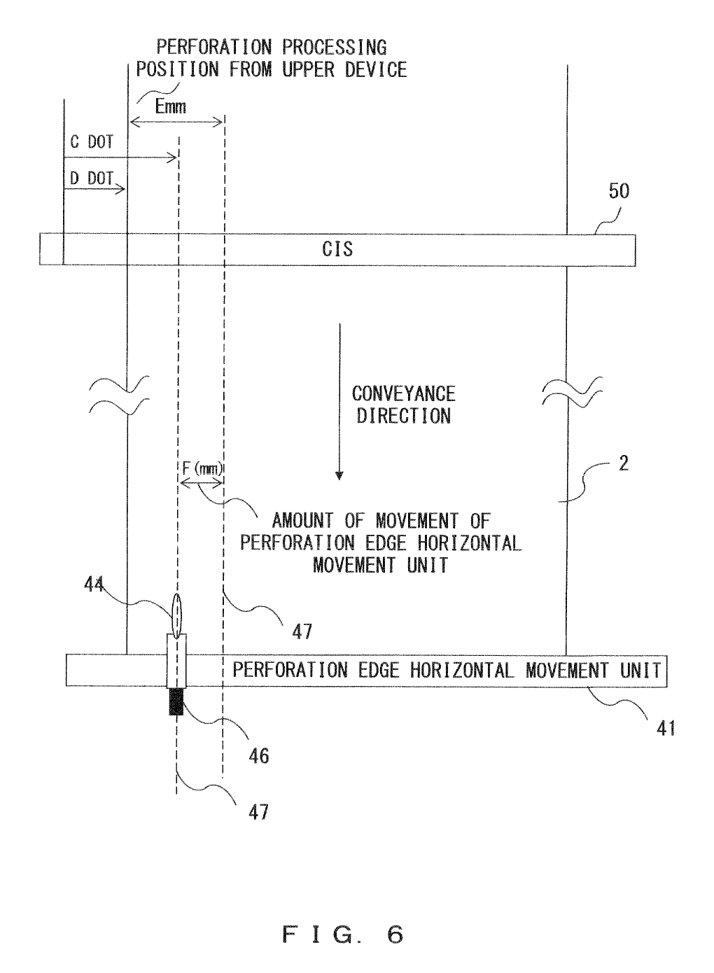

FIG. 6 is an explanatory view of the controlling method in the medium end portion following mode.

When the record medium 2 is conveyed along the conveying path for record of images, the medium end portion detection unit 50 detects the side end portion of the recording medium 2, and notifies the control unit 10 of the dot position ID (dot) from the reference position of the element configuring the medium end portion detection unit 50 which has detected the side end portion.

The control unit 10 calculates the amount F (mm) of the horizontal movement from the position of the origin sensor of the perforation edge horizontal movement unit 41-1 using the dot position D (dot), the position C (dot) of the origin sensor 46 as described above, and the perforation processing position E (mm) (distance from the reference position) notified from the upper device 23.

F=E−((C−D)×25.5/300)

The control unit 10 notifies the perforation edge horizontal movement unit 41 of the amount of movement of F mm. The perforation edge horizontal movement unit 41 moves the perforating edge 44 to the position notified from the upper device 23, operates the cam motor 45 at a predetermined position of a predetermined sheet, and provides the perforation.

By performing the above-mentioned control, a user can provide the perforation at a specified position from the record medium end portion intended when generating an image recording draft.

Described next is the method of providing perforation in the image reference following mode.

In the image reference following mode, the perforation is provided with reference to the reference position set in the image to be recorded in the record medium 2.

FIG. 5B illustrates a method of providing perforation in the image reference following mode.

As illustrated in FIG. 5B, an image 64 is recorded in the record medium 2 in the image reference following mode, and perforation 62-3 is provided at a position with reference to a reference position 65 (for example, at the center of the image 64) used in recording the image 64.

When the perforation is provided in the image reference following mode, the job information notified from the upper device 23 includes the information about the perforation. In FIG. 5B, the distance (a3 in FIG. 5B) from the reference position of the image 64, the length (b3 in FIG. 5B) of the perforation, and the starting position (63-3 in FIG. 5B) of the perforation are included as the information about the perforation in the image reference following mode. The perforation control unit 10d of the control unit 10 provides the perforation 62-3 based on the reference position 65 of the image according to the information about the perforation.

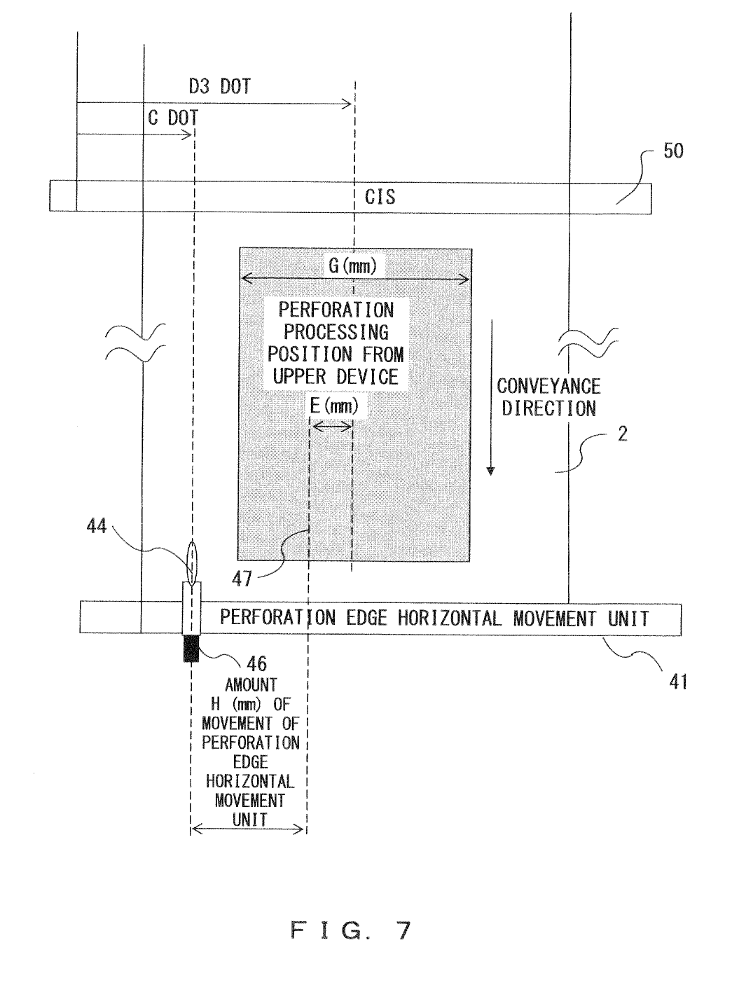

FIG. 7 is an explanatory view of a controlling method in the image reference following mode.

If the record medium 2 is conveyed on the conveyance path for recording an image, the control unit 10 converts the reference point, position (for example, the central position of the image) of the recorded image used when the image is recorded into the value D3 expressed by the coordinates system (the number of dots counted based on the dots of the reference position of the medium end portion detection unit 50) on the medium end portion detection unit 50.

The value D3 is stored as a image information table 48 in the storage unit 10a of the control unit with the sheet ID as an identifier of each sheet included in the job information from the upper device 23, the other information about each of sheets, for example, the perforation position, the presence/absence of the perforation, etc.

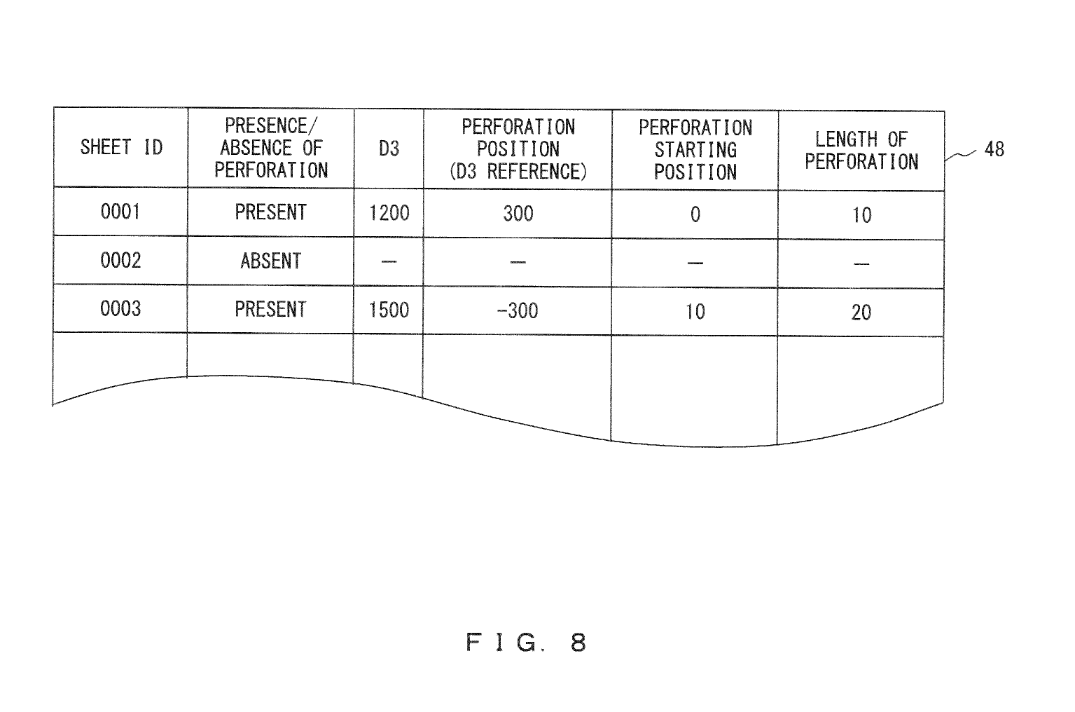

FIG. 8 is an example of a configuration of the image information table 48.

The image information table 48 is configured in the storage unit 10a by the control unit 10 according to the job information notified from the upper device 23.

In the image information table 48 in FIG. 8, the sheet ID identifying the sheet on which an image is recorded according to the notified job information, the presence/absence of the perforation, the value D3 indicating the above described reference position 65 of the image 64 as a reference by the coordinates system on the medium end portion detection unit 50, the position based on the D3 of the perforation (position in the width direction of the record medium 2), the starting position of the perforation (position in the vertical direction), and the length of the perforation are associated and stored. The point where the position of the perforation is assigned a minus value in the image information table 48 indicates that the perforation is located to the left of the reference position 65 in FIG. 5B.

Next, when the control unit 10 detects the conveyance of the record medium 2 on which an image has been recorded to the position of the perforation introducing unit 40, it refers to the image information table 48 in FIG. 8 by a corresponding sheet ID, thereby determining the presence/absence of the perforation. If no perforation is detected as a result of the determination, the record medium 2 is transmitted to the cutting unit 8 without operating the perforation introducing unit 40 and without any perforation. If the corresponding sheet is provided with perforation as a result of the reference to the image information table 48, the perforation is provided by controlling the perforation introducing unit 40 based on the corresponding value of the D3 in the image information table 48, the position of the perforation, the starting position of the perforation, and the length of the perforation.

As illustrated in FIG. 7, the control unit 10 calculates the amount H (mm) of horizontal position movement of the perforation edge horizontal movement unit 41 by the following equation using the perforation position E (mm) and the value of D3 (dot) read from the image information table 48 and the position C (dot) of the origin sensor 46.

H=(D3×25.4/300)−E−(C×25.4/300)

The control unit 10 notifies the perforation edge horizontal movement unit 41 of the amount H (mm) of horizontal position movement, and moves the perforating edge 44 to the position specified by the upper device 23. Thus, the perforation 47 can be provided in the predetermined position with reference to the recorded image 64.

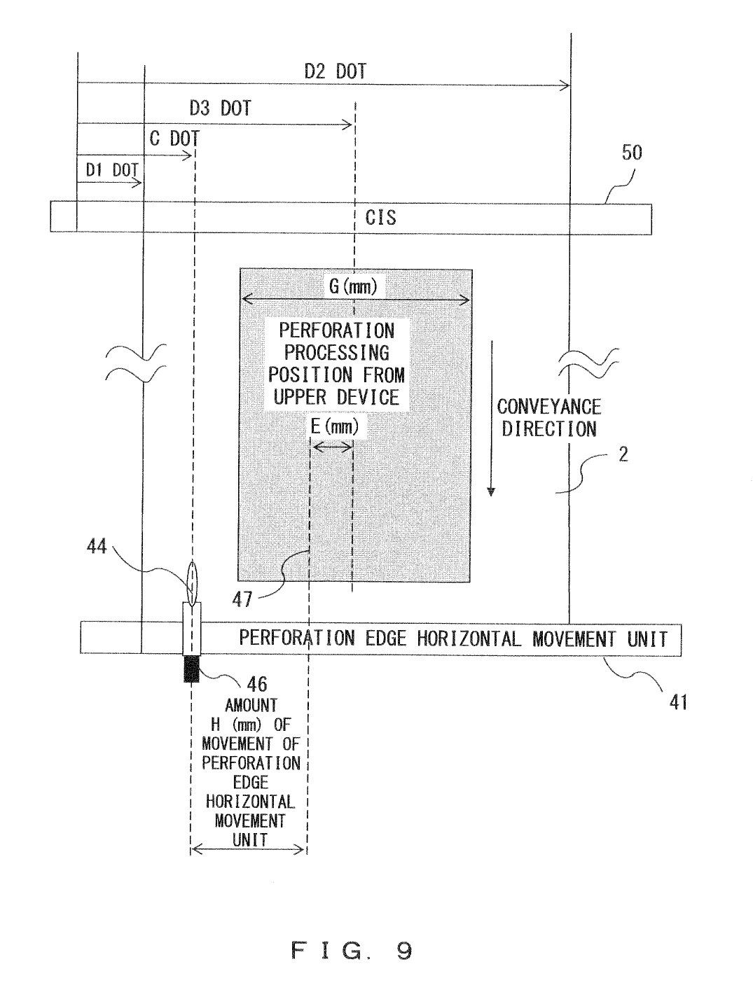

Described next is the case in which the reference position 65 of the reference image 64 falls in the center of the record medium 2 in the width direction. The reference position 65 is assumed to be located in the center of the image 64, and FIG. 9 is the schematic diagram of the case.

The medium end portion detection unit 50 detects the both side end portions of the conveyed record medium 2, and notifies the control unit 10 of the positions of the side end portions as the information D (D1, D2) (dot) in the coordinates system on the medium end portion detection unit 50.

The control unit 10 records the image 64 so that the center of the record medium 2 in the width direction match the center of the image 64 to be recorded according to the information D (dot) when the image recording process is performed. The central position D3 (dot) of the record medium 2 in the width direction can be obtained by the following equation using the position D1 (dot) of the left end portion and the position D2 (dot) of the right end portion.

D3=(D1+D2)/2

Using the value of the central position D3 (dot) in the width direction, the amount H (mm) of horizontal position movement of the perforation edge horizontal movement unit 41 is calculated, and the perforation is provided using the obtained value. Thus, the center of the recorded image 64 matches the center of the conveyed record medium 2 in the width direction, there by recording the image in the center of the record medium, and the perforation can be provided in a predetermined position with reference to the center of the image 64.

The center of the record medium 2 in the width direction can also be obtained from one of the values of the information D1 (dot) and D2 (dot) and the specified value of the record medium 2 for obtaining the width of the record medium 2.

The perforation can be provided with reference to the image 64 independent of the width of the record medium 2 by controlling the perforation processing in the image reference following mode. Therefore, the perforation can be provided according to the position relationship between the image 64 and the perforation 47 as desired by a user.

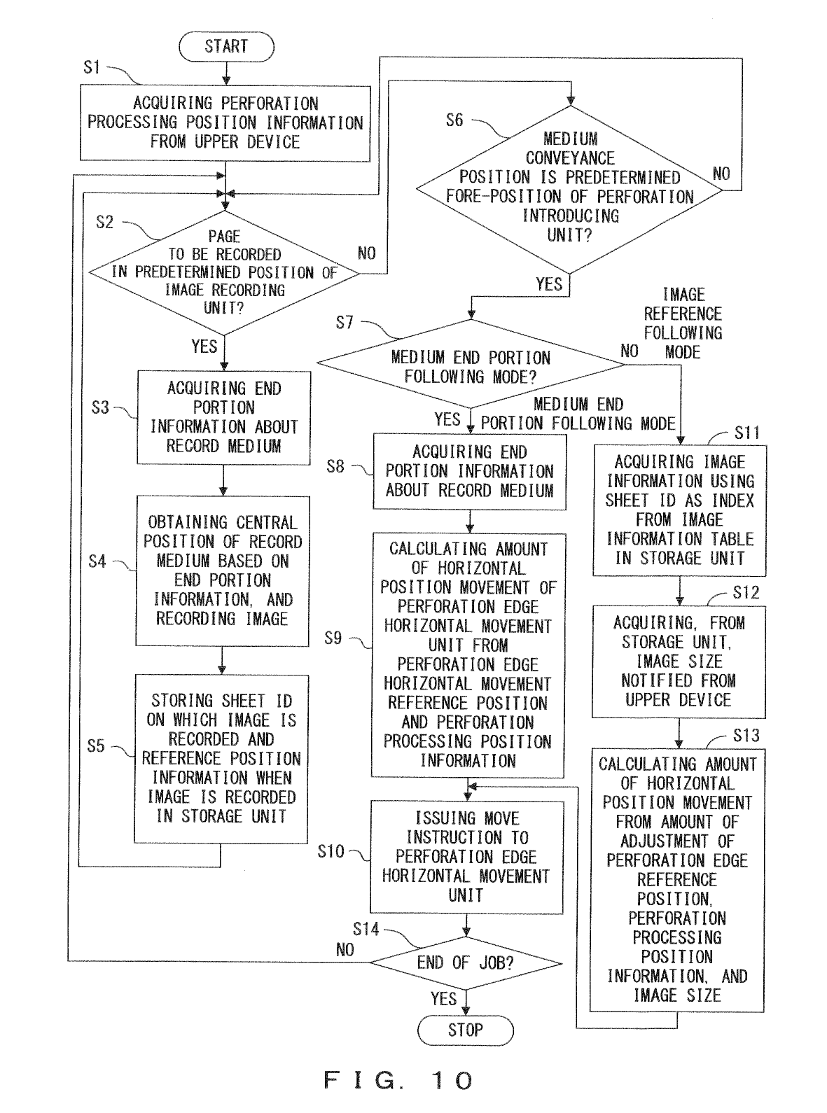

FIG. 10 is a flowchart of the operation in the perforation processing performed by the image recording apparatus 1 according to the present embodiment.

The process in FIG. 10 is realized by the control unit 10 executing the control program in the storage unit 10a.

When the process in FIG. 10 is started, the control unit 10 first receives the job information from the upper device 23, and acquires the perforation processing position information in the job information in step S1.

Next, the control unit 10 determines in step S2 whether or not the page on which an image is to be recorded is placed in the predetermined record position of the first image recording unit 5 or the second image recording unit 6.

If it is determined that the page on which an image is to be recorded is in the predetermined record position of the first image recording unit 5 or the second image recording unit 6 (YES in step S2), the process proceeds to step S3. In step S3, the information about the positions of the end portions of the record medium 2 is obtained from the medium end portion detection unit 50. In step S4, the control unit 10 obtains the central position of the record medium 2 according to the information about the positions of the end portions of the record medium 2 acquired in step S3, and the image is recorded on the record medium 2. Then, in step S5, the control unit 10 stores the reference position of the image recorded with the sheet ID of the sheet on which the image is recorded in step 4, the reference position of the recorded image, and the perforation processing position information acquired in step S1 as the image information table 48 in the storage unit 10a, and the process then returns step S2.

If it is determined in step S2 that the page on which the control unit 10 is to record an image is not in the predetermined record position of the first image recording unit 5 or the second image recording unit 6 (NO in step S2), then the process proceeds to step 6. In step S6, the control unit determines whether or not the conveyance position of the record medium 2 is in the predetermined fore-position of the perforation introducing unit 40. If the conveyance position of the record medium 2 is not in the predetermined fore-position of the perforation introducing unit 40 (NO in step S6) as a result of the determination, the process returns to step S2.

If the control unit 10 determines in step S6 that the conveyance position of the record medium 2 is in the predetermined fore-position of the perforation introducing unit 40 (YES in step S6), the process proceeds to step 7. In step 7, the control unit 10 determines according to the job information whether the mode of the perforation processing is the medium end portion following mode or the image reference following mode.

If the specification of the mode for the perforation processing is the medium end portion following mode as a result of the determination in step S7 (YES in step S7), the sheet corresponding to the record medium 2 currently in the perforation introducing unit 40 is provided with the perforation in the medium end portion following mode.

In the medium end portion following mode, the perforation control unit 10d of the control unit 10 acquires the end portion information about the position of the side end portion of the record medium 2 from the medium end portion detection unit 50 in step S8. Next, in step S9, the perforation control unit 10d calculates and obtains the amount of movement of the perforation edge horizontal movement unit 41 from the reference position of the perforation edge horizontal movement unit 41 and the perforation processing position information obtained in step S1. Then, in step S10, the perforation control unit 10d instructs the perforation edge horizontal movement unit 41 to move to the position calculated in step S9, and the perforation edge horizontal movement unit 41 moves to the instructed position and provides the perforation for the record medium 2.

On the other hand, if the specification of the mode for the perforation processing is the image reference following mode as a result of the determination in step S7 (NO in step S7), the sheet corresponding to the record medium 2 currently in the perforation introducing unit 40 is processed in the perforation processing in the image reference following mode.

In the image reference following mode, the perforation control unit 10d refers to the image information table 48 stored in the storage unit 10a in step S5 on the basis of the sheet ID, and acquires the reference point position D3 of the recorded image and the perforation processing position E (mm) in step S11. Next, the perforation control unit 10d acquires the size G (mm) of the image from the storage unit 10a according to the job information received from the upper device 23 in step S12. In step S13, the perforation control unit 10d calculates the amount H (mm) of horizontal position movement of the perforation edge horizontal movement unit 41 from the reference point position D3 (dot) of the recorded image acquired in steps S11 and S12, the perforation processing position E (mm), the size G (mm) of the image, and the perforation edge reference position C (dot). The perforation control unit 10d directs to move the perforation edge horizontal movement unit 41 by the amount H (mm) of horizontal position movement in step S10, and the perforation edge horizontal movement unit 41 moves to the instructed position, and provides perforation for the record medium 2.

Then, the control unit 10 determines in step S14 whether or not all image record instructions in the job information have been completely processed. If there is any unprocessed image record instruction as d result of the determination (NO in step S14), the process returns to step S2. If all image record instructions have been processed as a result of the determination (YES in step S14), the present process is terminated.

In the image recording apparatus 1 according to the present embodiment, the perforation can be provided for the record medium without setting a mark on the record medium in advance.

In addition, the perforation processing has two modes, that is, the medium end portion following mode and the image reference following mode. If the perforation processing is performed in the medium end portion following mode, the perforation can be provided in the specified position from the end portion of the record medium intended by the user when an image recording draft is generated. Since the positions of the side end portions of the record medium 2 are detected for each sheet, a shift or an error of the record medium 2 can be appropriate addressed. In addition, when the perforation processing is performed in the image reference following mode, the perforation processing can be performed with reference to the image which has recorded. Therefore, the perforation can be provided according to the position relationship between the record image and the perforation as desired by a user.

As described above, according to the image recording apparatus 1 of the present invention, vertical perforation can be provided at a predetermined position of the record medium based on the instruction from an upper device. Furthermore, the vertical perforation can be provided at a predetermined position with reference to the image recorded on the record medium.

In the description above, the medium end portion detection unit 50 used in the image recording apparatus 1 according to the present embodiment is a CIS, but the medium end portion detection unit 50 is not limited to the CIS and may be another detection sensor.

In addition, the embodiment according to the present invention is not limited to the embodiments above, but can be realized by transforming the components within the scope of the gist in practice. Furthermore, according to some embodiments of the present invention, various aspects can be realized by appropriately combining a plurality of components disclosed in the embodiment above. For example, in some embodiments of the present invention, some components can be deleted from all components used in the embodiments above or different components in each embodiment can be appropriately combined.

What is claimed is:

1. An image recording apparatus which records an image on a record medium according to job information from an upper device, comprising:
a perforation control unit calculating an amount of movement in a direction substantially orthogonal to a conveyance direction of the record medium based on a reference position, and issuing an instruction to perform perforation processing based on the amount of movement; and
a perforation edge horizontal movement unit moving based on the instruction and providing perforation on the record medium.

2. The image recording apparatus according to claim 1, further comprising
a control unit comprising at least a processing unit and a storage unit storing in advance a control program, wherein
the control unit functions as the perforation control unit by causing the processing unit to execute the control program.

3. The image recording apparatus according to claim 1, further comprising
a medium end portion detection unit detecting a position of an end portion of the record medium substantially parallel to a conveyance direction of the record medium, wherein
the perforation control unit calculates the amount of movement using the position of the end portion detected by the medium end portion detection unit as the reference position.

4. The image recording apparatus according to claim 1, further comprising
an image recording unit recording an image on the record medium, wherein
the perforation control unit calculates the amount of movement using the position based on the image recorded by the image recording unit as the reference position.

5. The image recording apparatus according to claim wherein
the perforation control unit calculates the amount of movement using as the reference position a reference position used when the image recording unit records the image.

6. The image recording apparatus according to claim 4, wherein
the perforation control unit calculates the amount of movement using as the reference position a central position of the image recorded by the image recording unit.

7. The image recording apparatus according to claim 4, further comprising
a medium end portion detection unit detecting the position of the end portion of the record medium substantially parallel to a conveyance direction of the record medium, wherein:
the position based on the image recorded by the image recording unit is defined as the central position in a width direction of the record medium; and
the perforation control unit obtains the reference position from both end portions of the medium detected by the medium end portion detection unit.

8. The image recording apparatus according to claim 4, wherein
the image recording unit records the image on at least one of a front surface and a back surface of the record medium.

9. The image recording apparatus according to claim 1, wherein
the perforation edge horizontal movement unit provides the perforation parallel to a conveyance direction of the record medium for the record medium.

10. The image recording apparatus according to claim 1, further comprising
a cutting unit cutting the record medium in a predetermined dimension in synchronization with the perforation processing by the perforation edge horizontal movement unit according to the job information, wherein
the record medium is a roll of paper.

11. A method for controlling an image recording apparatus which records an image on a record medium according to job information from an upper device, comprising:
calculating an amount of movement in a direction substantially orthogonal to a conveyance direction of the record medium based on a reference position, and issuing an instruction to perform perforation processing based on the amount of movement; and
moving based on the instruction and issuing a instruction to provide perforation on the record medium.

12. The method according to claim 11, further comprising:
detecting a position of an end portion of the record medium substantially parallel to a conveyance direction of the record medium; and
calculating the amount of movement using the position of the end portion detected as the reference position.

13. The method according to claim 11, further comprising:
recording an image on the record medium; and
calculating the amount of movement using the position based on the image as the reference position.
